(19) United States
(12) Patent Application Publication
(10) Pub. No.: US 2012/0262833 A1
(43) Pub. Date: Oct. 18, 2012

(54) MOTOR CONTROL APPARATUS AND BUSH THEREFOR

(75) Inventors: Kazutaka KISHIMOTO, Fukuoka (JP); Makoto Kojyo, Fukuoka (JP); Tomohiro Shigeno, Fukuoka (JP)

(73) Assignee: KABUSHIKI KAISHA YASKAWA DENKI, FUKUOKA (JP)

(21) Appl. No.: 13/366,364

(22) Filed: Feb. 6, 2012

(30) Foreign Application Priority Data
Apr. 14, 2011 (JP) 2011-089988

(51) Int. Cl. H01H 50/12

(52) U.S. Cl. 361/142

(57) ABSTRACT

A motor control apparatus includes a housing base. A main body is disposed on a first surface of the housing base and includes a plurality of electronic components associated with driving of the motor. An air duct is disposed on a second surface of the housing base, and cooling air flows through the air duct. A through hole is disposed in the housing base and has a tapered inner surface. A bush is fitted and secured in the through hole. The bush has a tapered outer surface and includes a cable insertion hole and a close contact portion. A cable is disposed through the cable insertion hole and the housing base and is wired between the main body and the air duct. The cable has an outer surface in close contact with the close contact portion of the bush outside the through hole.

### CROSS-REFERENCE TO RELATED APPLICATIONS

The present application claims priority under 35 U.S.C. §119 to Japanese Patent Application No. 2011-089988, filed Apr. 14, 2011. The contents of this application are incorporated herein by reference in their entirety.

### BACKGROUND OF THE INVENTION

1. Field of the Invention

The present invention relates to a motor control apparatus and a bush for the motor control apparatus.

2. Discussion of the Background

Japanese Unexamined Patent Application Publication No. 2003-274597 discloses an outlet structure of a cable (detector cable) of an electric motor. This conventional outlet structure includes a bush (rubber bush) having a conical outer surface. The bush is molded around the outer circumference of the cable over a through hole (cable hole) of a housing base (detector cover).

### SUMMARY OF THE INVENTION

According to one aspect of the present invention, a motor control apparatus is configured to control driving of a motor. The motor control apparatus includes a housing base, a main body, an air duct, a through hole, a bush, and at least one cable. The housing base has a first surface and a second surface. The main body is disposed on the first surface of the housing base and includes a plurality of electronic components associated with driving of the motor. The air duct is disposed on the second surface of the housing base, and cooling air flows through the air duct. The through hole is disposed in the housing base and has a tapered inner surface. The bush is fitted and secured in the through hole. The bush has a tapered outer surface and includes at least one cable insertion hole and at least one close contact portion. The at least one cable is disposed through the at least one cable insertion hole and the housing base and is wired between the main body and the air duct. The at least one cable has an outer surface in close contact with the at least one close contact portion of the bush outside the through hole.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view, on the air duct side, of an inverter device according to an embodiment;

FIGS. 2A and 2B are longitudinal sectional views of a housing base adjacent to its through hole, illustrating the structure of the through hole and a rubber bush;

FIG. 3 is a diagram illustrating an exemplary wiring of electronic components and cables disposed at the main body and the air duct;

FIGS. 4A and 4B are longitudinal sectional views of a housing base adjacent to its through hole, illustrating the structure of a rubber bush according to a comparative example;

FIGS. 5A and 5B are longitudinal sectional views of a housing base adjacent to its through hole, illustrating the structure of the rubber bush according to a modification where a protruding opening portion is disposed only at an opening end surface at the side of the air duct;

FIG. 6 is a perspective view, on the air duct side, of an inverter device according to a modification where the rubber bush includes a plurality of cable insertion holes; and

FIGS. 7A and 7B are longitudinal sectional views of a housing base adjacent to its through hole, illustrating the structure of the through hole and the rubber bush.

### DESCRIPTION OF THE EMBODIMENTS

The embodiments will now be described with reference to the accompanying drawings, wherein like reference numerals designate corresponding or identical elements throughout the various drawings.

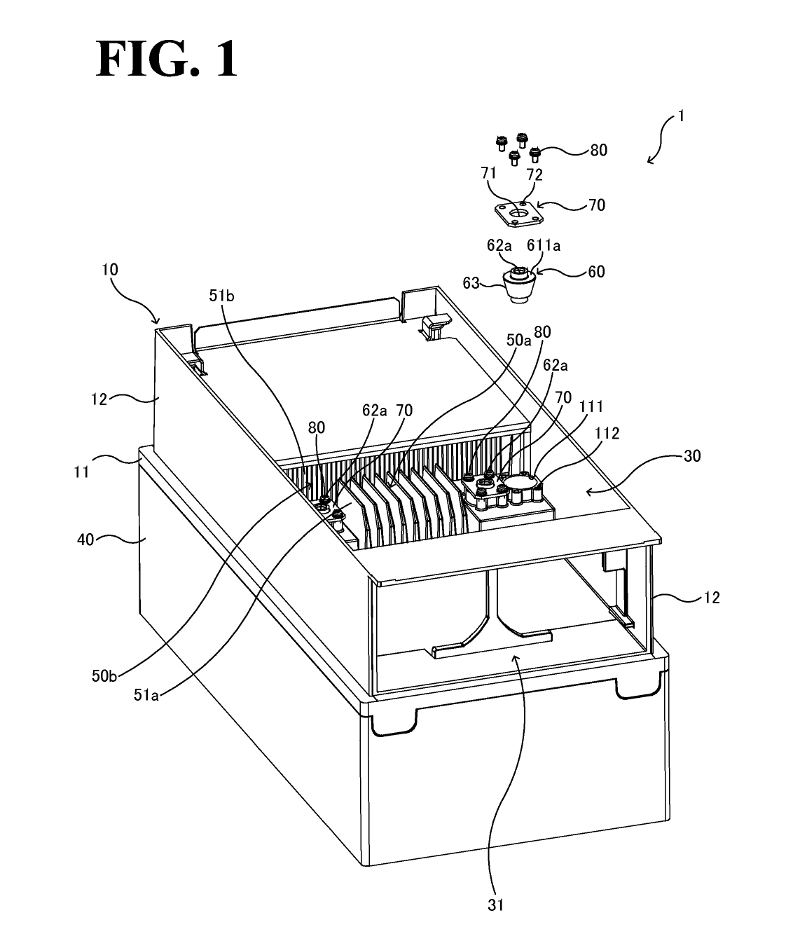

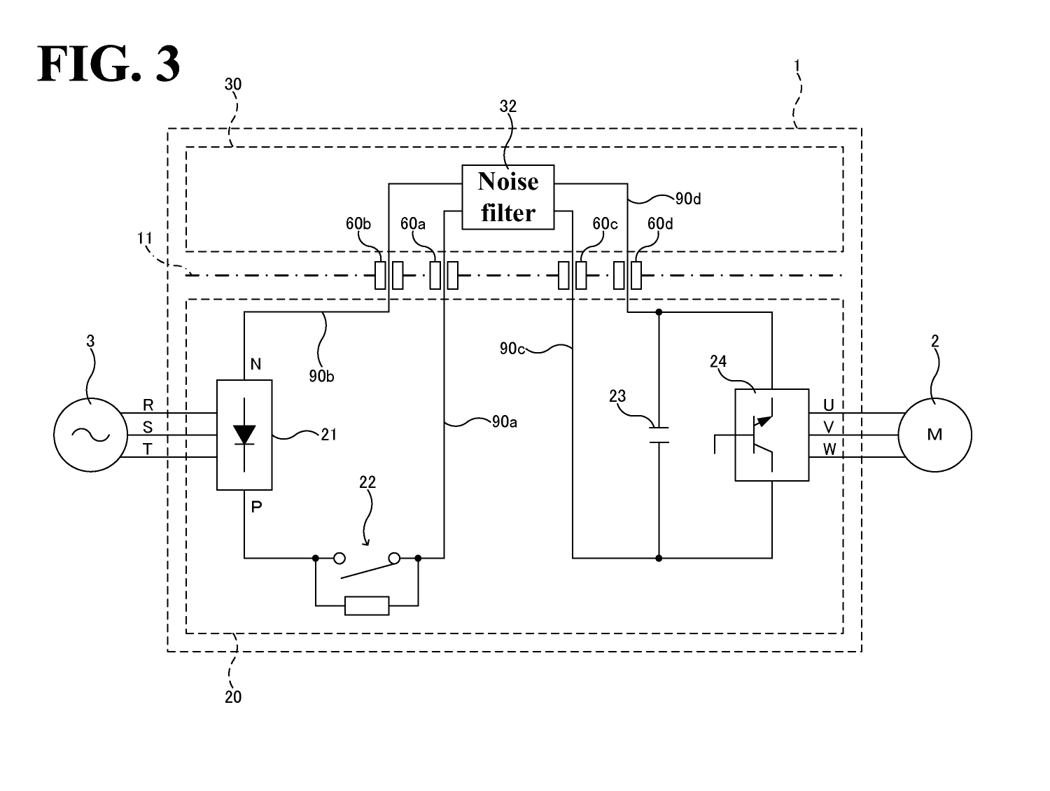

As shown in FIG. 1, an inverter device 1 (motor control apparatus) according to an embodiment is an apparatus to control driving of a motor 2 (see FIG. 3, described later). The inverter device 1 includes a housing 10, a main body 20 (see FIG. 3, described later), an air duct 30, and a casing 40. Cooling air flows through the air duct 30. The casing 40 accommodates the main body 20.

The housing 10 includes a housing base 11 and two air duct walls 12. The two air duct walls 12 are disposed upright on the rear surface of the housing base 11 (in other words, on the other surface of the housing base 11, as seen on the upper side in FIG. 1). The two air duct walls 12 constitute side walls of the air duct 30. The housing base 11 and the air duct walls 12 are integrally molded by die-casting or other methods from aluminum alloys (examples including, but not limited to, ADC12 alloy, which is an Al—Si—Cu alloy). As used herein, the term die-casting refers to a mold casting method by which molten metal is pressed into a mold to make molded articles in large quantities with high dimensional accuracy in short time. The term die casting also refers to products resulting from the mold casting method. Other examples of the die-casting alloy than aluminum alloys include, but not limited to, zinc alloys and magnesium alloys. The housing base 11 and the air duct walls 12 may be individually die-cast and joined to one another with, for example, bolts.

The main body 20 is disposed on the front surface of the housing base 11 (in other words, on one surface of the housing base 11, as seen on the lower side in FIG. 1), while the air duct 30 is disposed on the rear surface of the housing base 11. The inverter device 1 is usually disposed on the control board or other members such that the main body 20 (in other words, the front surface of the housing base 11) is on the front side, while the air duct 30 (in other words, the rear surface of the housing base 11) is on the rear side. In the FIG. 1, the inverter device 1 is illustrated with the main body 20 on the lower side and the air duct 30 on the upper side, which is contrary to the usual state in the assembly process, where the main body 20 is on the upper side, while the air duct 30 is on the lower side. In the main body 20 and the air duct 30, electronic components (not shown in FIG. 1 but in FIG. 3, described later) associated with the driving of the motor 2 are disposed. The air duct 30 includes fins 51a of a heat sink 50a and fins 51b of a heat sink 50b. The fins 51a and the fins 51b are made of a highly heat conductive material (examples including, but not limited to, an aluminum alloy). The heat sinks 50a and 50b are disposed at positions corresponding to the heat dissipating components among the electronic components in the main body 20 (examples of the heat dissipating components including, but not limited to, a diode module 21 and a power module 24 shown in FIG. 3, described later). The heat sinks 50a and 50b discharge heat of the heat dissipating components, thereby cooling the heat dissipating components. Additionally, at one end of the air duct 30 (that is, at one end of each air duct wall 12), an opening 31 is disposed. The opening 31 is to be oriented, for example, in the top side direction. The opening 31 is to be attached with a fan (not shown) to generate cooling air.

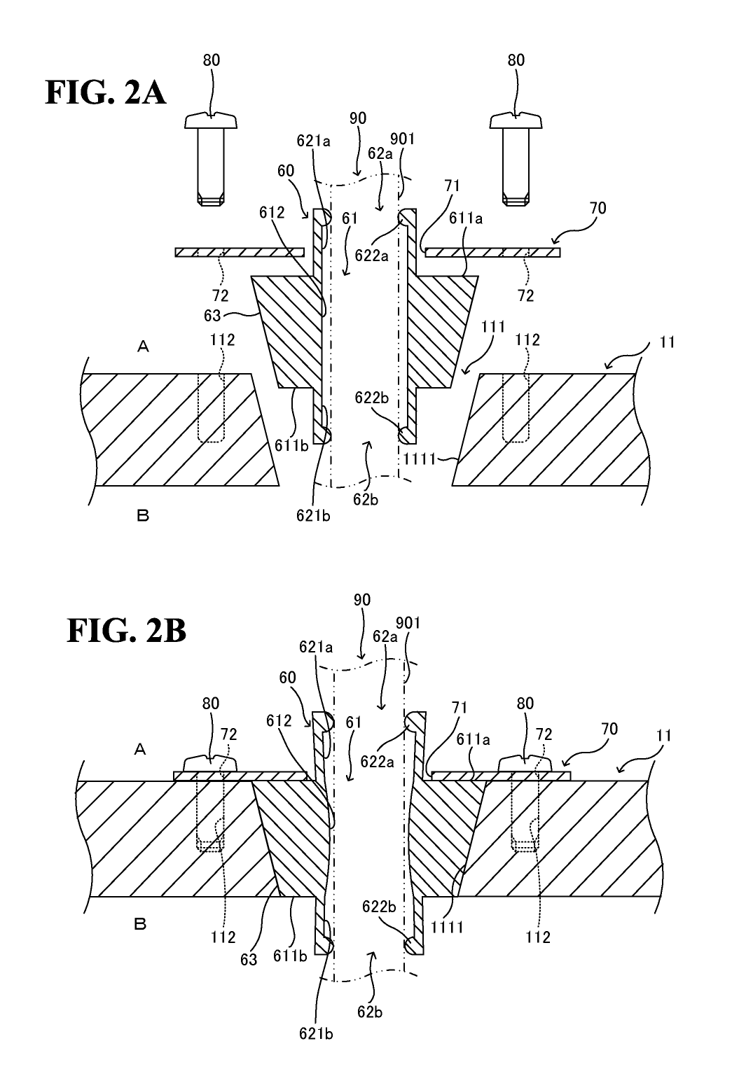

The housing base 11 includes a plurality of (four in this embodiment) through holes 111 (only one is shown in FIG. 1). In each of the through holes 111, a rubber bush 60 (bush) is fitted. The rubber bush 60 has an approximately circular overall shape. The rubber bush 60 permits a cable 90 (which is not shown in FIG. 1 but in FIGS. 2A and 2B, described later) to pass through the rubber bush 60 so as to couple an electronic component at the side of the main body 20 to an electronic component at the side of the air duct 30. The rubber bush 60 is secured under a steel plate 70 (clamping plate). The steel plate 70 is secured to the housing base 11 with four screws 80.

Next, referring to FIGS. 1, 2A, and 2B, the structure of the through hole 111 of the housing base 11 and the rubber bush 60 will be detailed. FIG. 2A shows the rubber bush 60 prior to being fitted and secured in the through hole 111. FIG. 2B shows the rubber bush 60 fitted and secured in the through hole 111.

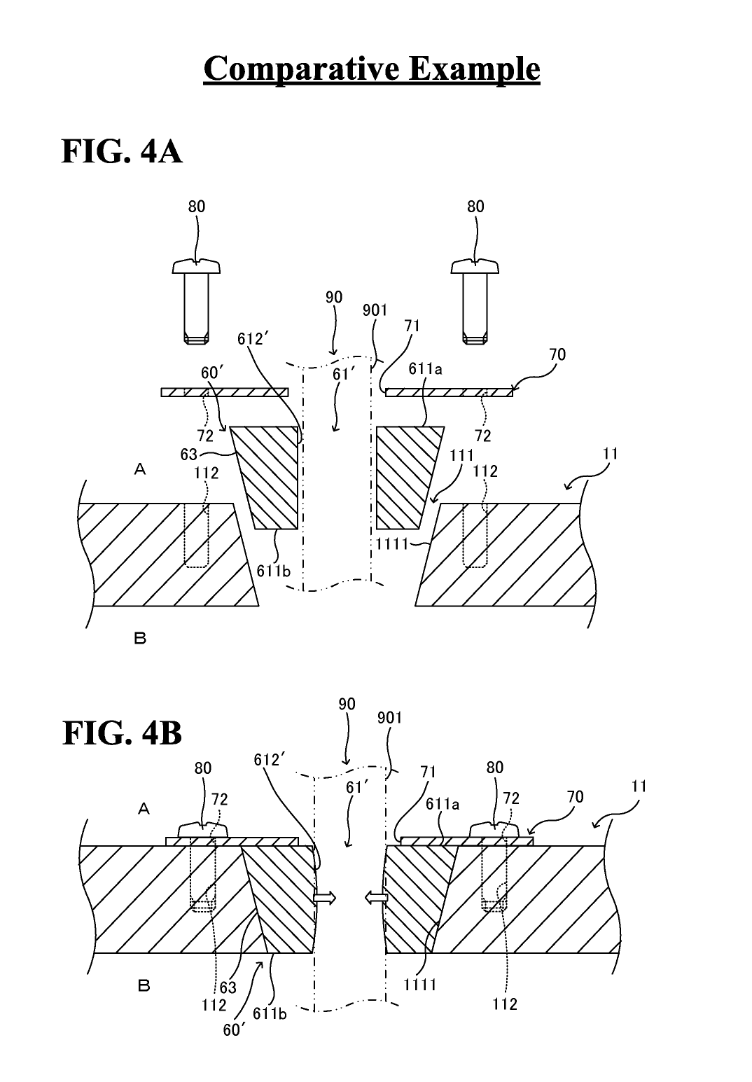

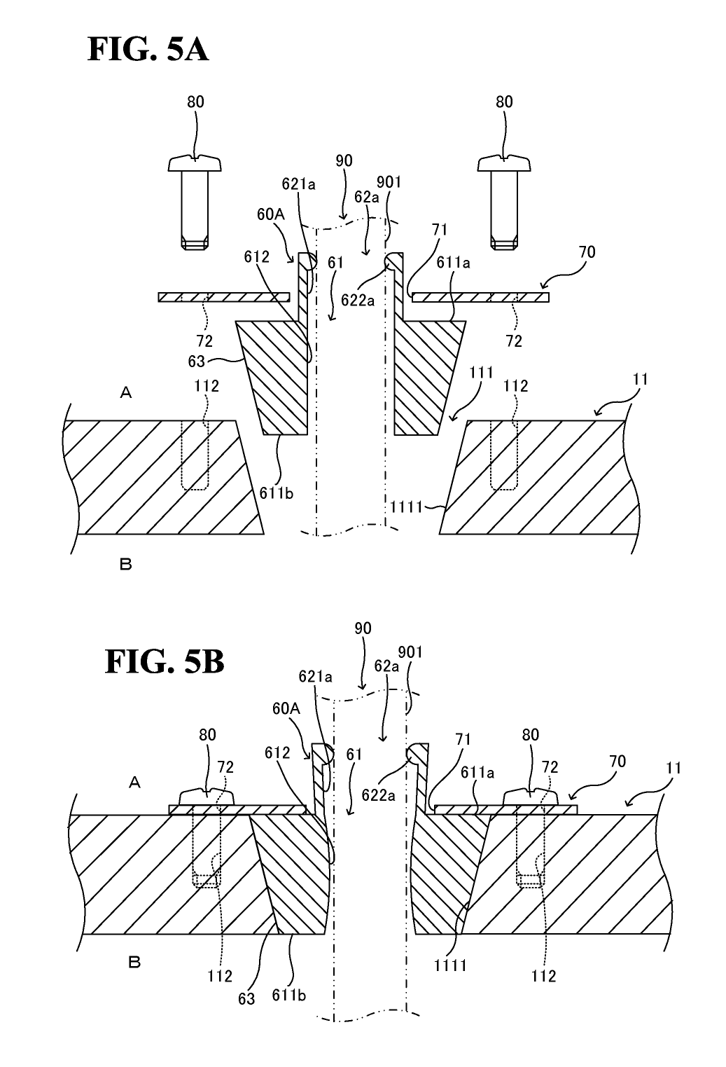

As shown in FIGS. 1, 2A, and 2B, the through hole 111 of the housing base 11 includes an inner surface 1111, which is tapered from the air duct 30 side (in other words, from the “A” side in FIGS. 2A and 2B, which also applies to FIGS. 4A, 4B, 5A, and 5B, described later) to the main body 20 side (in other words, to the “B” side in FIGS. 2A and 2B, which also applies to FIGS. 4A, 4B, 5A, and 5B, described later). The housing base 11 includes, on its surface at the side of the air duct 30, four screw holes 112 around the through hole 111.

The rubber bush 60 has an outer surface 63, which is tapered corresponding to the inner surface 1111 of the through hole 111. The rubber bush 60 includes a cable insertion hole 61 having an approximately circular cross-section. The cable 90 is to be passed through the cable insertion hole 61. The rubber bush 60 also includes cylindrical protruding opening portions 62a and 62b (close contact portions). The cable insertion hole 61 is open at two opening end surfaces 611a and 611b, and the protruding opening portions 62a and 62b protrude respectively from the opening end surfaces 611a and 611b in the insertion directions of the cable 90. The cable insertion hole 61 has an inner diameter that is larger than the outer diameter of the cable 90. The cable insertion hole 61 has an inner surface 612. With the rubber bush 60 fitted in the through hole 111, the inner surface 612 receives pressure from the inner surface 1111 of the through hole 111 and expands in the inside direction. In this respect, with the cable 90 passed through the cable insertion hole 61, the inner surface 612 is kept from close contact with an outer surface 901 of the cable 90 (in other words, only slight contact or no contact is permitted). The protruding opening portions 62a and 62b respectively have inner surfaces 621a and 62 lb continuous from the cable insertion hole 61. The protruding opening portions 62a and 62b respectively have circumferential protruding portions 622a and 622b respectively at outer end portions of the inner surfaces 621a and 621b. With the rubber bush 60 fitted in the through hole 111, the protruding portions 622a and 622b, respectively of the protruding opening portions 62a and 62b, come into close contact with the outer surface 901 of the cable 90 outside the through hole 111 (with a level of pressure that allows for movement of the cable 90 in its insertion directions).

The rubber bush 60 thus configured is fitted into the through hole 111 of the housing base 11 from the air duct 30 side and secured under the steel plate 70. In this respect, the inner surface 612 of the cable insertion hole 61 of the rubber bush 60 expands in the inside direction due to the pressure from the inner surface 1111 of the through hole 111. The inner surface 612, however, is kept from close contact with the outer surface 901 of the cable 90 passed through the cable insertion hole 61. Instead, the protruding portions 622a and 622b, respectively of the protruding opening portions 62a and 62b, of the rubber bush 60 come into close contact with the outer surface 901 of the cable 90 outside the through hole 111. Thus, the cable insertion hole 61 is hermetically sealed. The steel plate 70, which secures the rubber bush 60, includes an insertion hole 71 and four screw insertion holes 72, into which the screws 80 are to be screwed. The steel plate 70 is placed over the opening end surface 611a of the rubber bush 60 at the side of the air duct 30 and the surface of the housing base 11 at the side of the air duct 30 so as to permit the protruding opening portion 62a of the rubber bush 60 at the side of the air duct 30 to pass through the insertion hole 71. In other words, the steel plate 70 is placed to cover the gap between the rubber bush 60 and the through hole 111 at the side of the air duct 30. Then, the four screws 80 are passed through the respective screw insertion holes 72 to be screwed into the respective screw holes 112 of the housing base 11. Thus, the steel plate 70 is secured to the surface of the housing base 11 at the side of the air duct 30.

Next, referring to FIG. 3, description will be made with regard to an exemplary wiring of the electronic components and cables 90 disposed in the main body 20 and the air duct 30.

In the embodiment of FIG. 3, the housing base 11 includes four through holes 111 (not shown), in which rubber bushes 60 (designated rubber bushes 60a, 60b, 60c, and 60d) are fitted and secured, with cables 90 (designated cables 90a, 90b, 90c, and 90d) passed through the respective cable insertion holes 61. The main body 20, which is disposed on the front surface of the housing base 11, includes a plurality of electronic components such as a diode module 21, an electromagnetic contactor 22, a main condenser 23, and the power module 24. The electromagnetic contactor 22 has a close/open controlled contact point. The air duct 30, which is disposed on the rear surface of the housing base 11, includes electronic components such as a noise filter 32, which removes noise.

The diode module 21 rectifies three-phase (R, S, T phase) alternating current power supplied from an alternating current source 3 and outputs direct current power to a positive cable 90a and a negative cable 90b. The cable 90a is passed through one of the cable insertion holes 61 of the rubber bush 60a and through the housing base 11, and wired between the diode module 21 (or the electromagnetic contactor 22), which is at the side of the main body 20, and the noise filter 32, which is at the side of the air duct 30. The cable 90b is passed through another one of the cable insertion holes 61 of the rubber bush 60b and through the housing base 11, and wired between the diode module 21, which is at the side of the main body 20, and the noise filter 32, which is at the side of the air duct 30.

The noise filter 32 removes noise contained in the direct current power supplied through the cables 90a and 90b, and outputs the noise-removed direct current to a positive cable 90c and a negative cable 90d. The cable 90c is disposed through another one of the cable insertion holes 61 of the rubber bush 60c and through the housing base 11, and wired between the noise filter 32, which is at the side of the air duct 30, and the power module 24 (or the main condenser 23), which is at the side of the main body 20. The cable 90d is disposed through the other one of the cable insertion holes 61 of the rubber bush 60d and through the housing base 11, and wired between the noise filter 32, which is at the side of the air duct 30, and the power module 24 (or the main condenser 23), which is at the side of the main body 20.

The main condenser 23 is coupled across the cables 90c and 90d so as to rectify input direct current power. The power module 24 includes a plurality of switching elements (only one of which is shown in FIG. 3 for simplicity) each including a semiconductor device such as an IGBT (Insulated Gate Bipolar Transistor). The power module 24 is coupled to the cables 90c and 90d, through which direct current power is supplied to the power module 24. The power module 24 outputs three-phase (U, V, W phase) alternating current power having a predetermined frequency to the motor 2.

In the inverter device 1 according to this embodiment, the main body 20 is disposed on the front surface of the housing base 11, while the air duct 30 is disposed on the rear surface of the housing base 11. The housing base 11 includes the four through holes 111, through which the four cables 90a, 90b, 90c, and 90d are passed to be wired between the main body 20 and the air duct 30. In order to eliminate a leakage of air from the air duct 30 to the main body 20, it is necessary to hermetically seal the through holes 111 and to cover the cables 90a, 90b, 90c, and 90d. In view of this, the rubber bushes 60a, 60b, 60c, and 60d are provided in the respective through holes 111, with the cables 90a, 90b, 90c, and 90d passed through the respective cable insertion holes 61 of the rubber bushes 60a, 60b, 60c, and 60d.

Prior to reciting advantageous effects of the above-described embodiment, a comparative example will be described by referring to FIGS. 4A and 4B. FIGS. 4A and 4B respectively correspond to FIGS. 2A and 2B. For ease of comparison, like reference numerals designate corresponding or identical elements throughout FIGS. 2A, 2B, 4A, and 4B.

As shown in FIGS. 4A and 4B, an inverter device 1 according to the comparative example and the inverter device 1 according to the above-described embodiment are similar, but different in that the inverter device 1 according to the comparative example includes a rubber bush 60′, as opposed to the rubber bush 60. Specifically, the rubber bush 60′ according to the comparative example has an outer surface 63 tapered corresponding to the inner surface 1111 of the through hole 111 of the housing base 11. The rubber bush 60′ includes a cable insertion hole 61′, through which the cable 90 is passed. The cable insertion hole 61′ has an inner diameter that approximately matches the outer diameter of the cable 90. The cable insertion hole 61′ has an inner surface 612′, which, with the rubber bush 60′ fitted in the through hole 111, expands in the inside direction due to the pressure from the inner surface 1111 of the through hole 111. With the cable 90 passed through the cable insertion hole 61′, the inner surface 612′ comes into close contact with the outer surface 901 of the cable 90. The rubber bush 60′ thus configured is fitted into the through hole 111 of the housing base 11 from the air duct 30 side and secured under the steel plate 70. The inner surface 612′ of the cable insertion hole 61′ of the rubber bush 60′ expands in the inside direction due to the pressure from the inner surface 1111 of the through hole 111, and comes into close contact with the outer surface 901 of the cable 90 passed through the cable insertion hole 61′. Thus, the cable insertion hole 61′ is hermetically sealed. The inverter device 1 according to the comparative example is otherwise similar to the inverter device 1 according to the above-described embodiment.

The following are noted regarding the inverter device 1 according to the comparative example. In the structure according to the comparative example, the close contact between the inner surface 612′ of the cable insertion hole 61′ of the rubber bush 60′ and the outer surface 901 of the cable 90 causes friction. Because of the friction, the cable 90 disposed through the cable insertion hole 61′ is fixed and difficult to move in the insertion directions. Thus, during wiring of the cable 90 in the main body 20 or the air duct 30, an operator cannot move the cable 90 through the rubber bush 60′ in the insertion directions and adjust the length of the cable 90. This may be detrimental to smoothness of the wiring operation of the cable 90.

Contrarily, in the inverter device 1 according to this embodiment, the rubber bush 60 includes the protruding opening portions 62a and 62b. The protruding opening portions 62a and 62b respectively have the protruding portions 622a and 622b in close contact with the outer surface 901 of the cable 90 passed through the cable insertion hole 60 outside the through hole 111. This eliminates or minimizes the influence that the pressure from the inner surface 1111 of the through hole 111 has on the protruding opening portions 62a and 62b, when the rubber bush 60 is fitted in the through hole 111. This ensures that the protruding opening portions 62a and 62b are in close contact with the outer surface 901 of the cable 90 with a suitable level of pressure that allows for movement of the cable 90 in its insertion directions. This, in turn, makes the cable 90 movable in the insertion directions while hermetically sealing the cable insertion hole 61 of the rubber bush 60. As a result, the operator is able to smoothly operate the wiring of the cable 90.

It is particularly noted that in this embodiment, the cylindrical protruding opening portions 62a and 62b protrude from both two opening end surfaces 611a and 611b, at which the cable insertion hole 61 of the rubber bush 60 is open. The inner surfaces 621a and 621b, respectively of the protruding opening portions 62a and 62b, are continuous from the cable insertion hole 61, and respectively have the circumferential protruding portions 622a and 622b. This configuration ensures a structure in which the protruding portions 622a and 622b respectively on the inner surfaces 621a and 621b are in close contact with the outer surface 901 of the cable 90 outside the through hole 111. The protruding opening portions 62a and 62b may be integrally die-cast with the rubber bush 60. Additionally, the protruding opening portions 62a and 62b are respectively disposed at the two opening end surfaces 611a and 611b, at which the cable insertion hole 61 of the rubber bush 60 is open. This ensures that the protruding portions 622a and 622b, respectively of the protruding opening portions 62a and 62b, are in close contact with the outer surface 901 of the cable 90 on both main body 20 side and air duct 30 side of the rubber bush 60. This improves the sealability of the cable insertion hole 61.

It is particularly noted that in this embodiment, the cable insertion hole 61 of the rubber bush 60 has an inner diameter that is larger than the outer diameter of the cable 90. This minimizes the close contact between the inner surface 612 of the cable insertion hole 61 and the outer surface 901 of the cable 90, when, with the rubber bush 60 fitted in the through hole 111, the inner surface 612 expands in the inside direction due to the pressure from the inner surface 1111 of the through hole 111. This eliminates or minimizes the fixation of the cable 90 in the cable insertion hole 61, which would otherwise be caused by friction of the close contact. This ensures movability of the cable 90.

It is particularly noted that in this embodiment, the rubber bush 60 is fitted into the through hole 111 from the air duct 30 side and secured under the steel plate 70. This securing structure ensures that the steel plate 70 covers the gap between the rubber bush 60 and the through hole 111 at the side of the air duct 30. This, in turn, further reduces the possibility of leakage of air of the air duct 30 into the main body 20.

Modifications will be described below.

### (1) A Protruding Opening Portion Disposed Only at the Opening End Surface at the Side of the Air Duct

In the above-described embodiment, the protruding opening portions 62a and 62b are disposed at both two opening end surfaces 611a and 611b, at which the cable insertion hole 61 of the rubber bush 60 is open. This, however, should not be construed in a limiting sense. It is also possible to dispose only the protruding opening portion 62a at the opening end surface 611a, which is at the side of the air duct 30, among the two opening end surfaces 611a and 611b.

As shown in FIGS. 5A and 5B, an inverter device 1 according to this modification and the inverter device 1 according to the above-described embodiment are similar, but different in that the inverter device 1 according to the modification includes a rubber bush 60A, as opposed to the rubber bush 60. Specifically, the rubber bush 60A according to this modification includes a protruding opening portion 62a only at the opening end surface 611a, which is at the side of the air duct 30, among the two opening end surfaces 611a and 611b, at which the cable insertion hole 61 is open. No protruding opening portion 62b is disposed at the opening end surface 611b, which is at the side of the main body 20. The rubber bush 60A is otherwise similar to the rubber bush 60 according to the above-described embodiment. The inverter device 1 according to this modification is otherwise similar to the inverter device 1 according to the above-described embodiment.

This modification provides similar advantageous effects to those in the above-described embodiment. Providing a single protruding opening portion 62 ensures a simple structure for the rubber bush 60A as compared with providing two protruding opening portions. The single rubber bush 60A, at the same time, reduces friction between the protruding portion 622 and the cable 90, improving the movability of the cable 90. Additionally, providing the protruding opening portion 62 at the opening end surface 611a, which is at the side of the air duct 30, hermetically seals the cable insertion hole 61 at the side of the air duct 30. This reduces the possibility of leakage of air of the air duct 30 into the main body 20.

(2) A Rubber Bush with a Plurality of Cable Insertion Holes

While in the above-described embodiment the rubber bush 60 includes a single cable insertion hole 61, this should not be construed in a limiting sense. The rubber bush 60 may include a plurality of cable insertion holes.

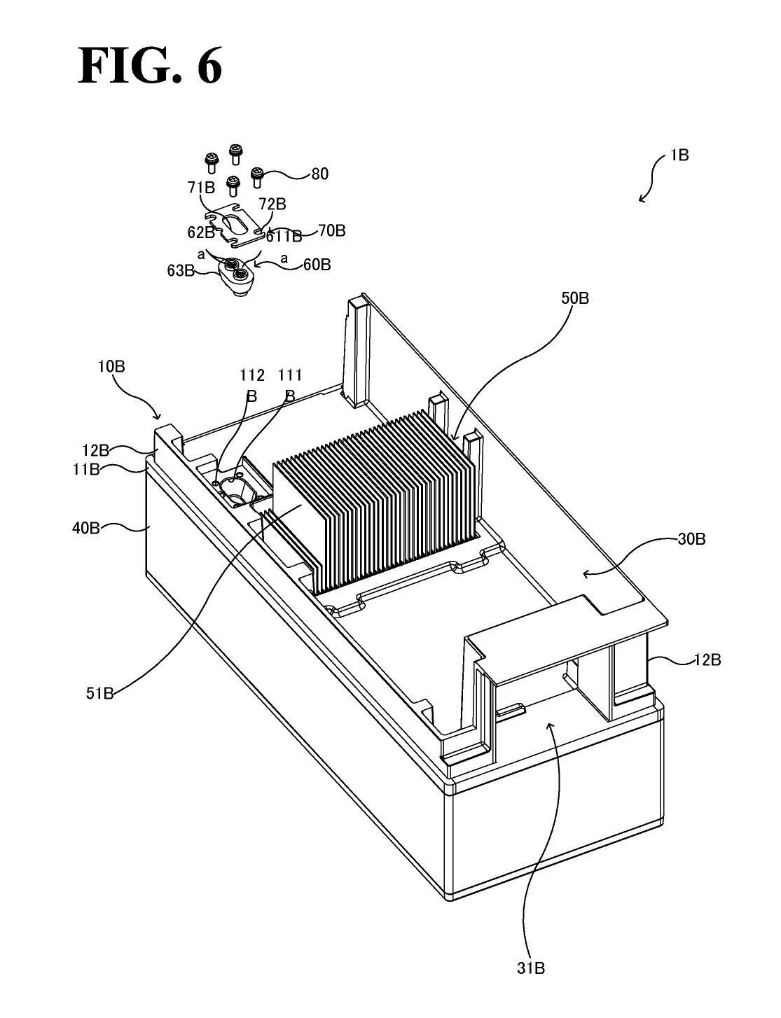

As shown in FIG. 6, an inverter device 1B (motor control apparatus) according to this modification includes a housing 10B (partially cutaway FIG. 6), a main body (not shown), an air duct 30B, and a casing 40B. Cooling air flows through the air duct 30B. The casing 40B accommodates the main body.

The housing 10B includes a housing base 11B and two air duct walls 12B (partially cutaway in FIG. 6). The two air duct walls 12B are disposed upright on the rear surface of the housing base 11B (in other words, on the other surface of the housing base 11B, as seen on the upper side in FIG. 6). The two air duct walls 12B constitute side walls of the air duct 30B. The main body is disposed on the front surface of the housing base 11B (in other words, on one surface of the housing base 11B, as seen on the lower side in FIG. 6). The air duct 30B is disposed on the rear surface of the housing base 11B. Electronic components (not shown in FIG. 6 but in FIG. 3, described above) associated with the driving of the motor 2 are disposed in the main body and the air duct 30B. The air duct 30B includes fins 51B (partially cutaway in FIG. 6) of a heat sink 50B made of a highly heat conductive material (examples including, but not limited to, an aluminum alloy). The heat sink 50B is disposed at a position corresponding to the heat dissipating components among the electronic components in the main body (examples of the heat dissipating components including, but not limited to, the power module 24 shown in FIG. 3, described above). The heat sink 50B discharges the heat of the heat dissipating components, thereby cooling the heat dissipating components. Additionally, at one end of the air duct 30B (that is, at one end of each air duct wall 12B), an opening 31B is disposed. The opening 31B is to be attached with a fan.

The housing base 11B includes a plurality of (two in this embodiment) through holes 111B (only one is shown in FIG. 6). In each of the through holes 111B, a rubber bush 60B (bush) is fitted. The rubber bush 60B has an approximately oval overall shape. The rubber bush 60B permits cables 90 (not shown in FIG. 6) to pass through the rubber bush 60B so as to couple electronic components at the side of the main body to electronic components at the side of the air duct 30B. The rubber bush 60B is secured under a steel plate 70B (clamping plate). The steel plate 70B is secured to the housing base 11B with four screws 80.

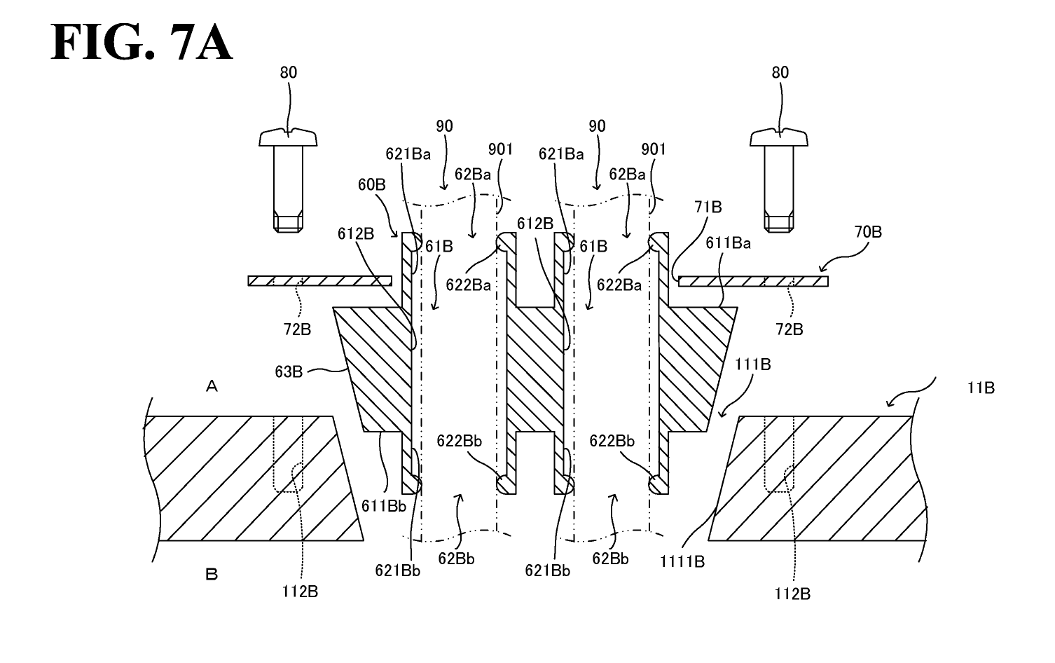

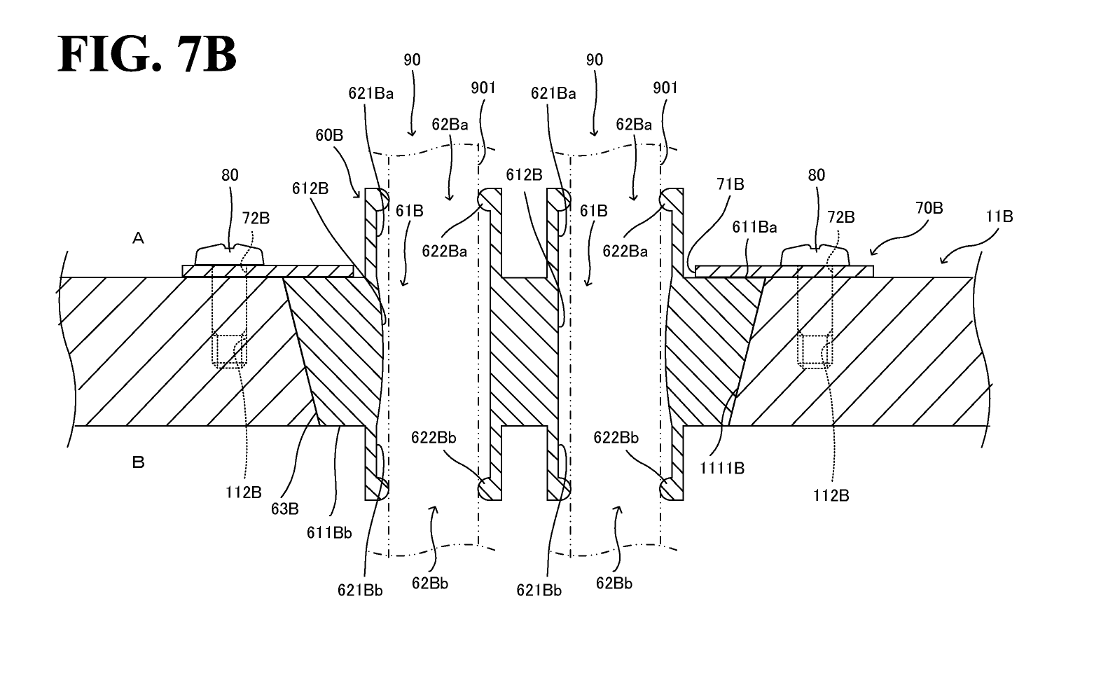

Next, referring to FIGS. 6, 7A, and 7B, the structure of the through hole 111B of the housing base 11B and the rubber bush 60B will be detailed. FIG. 7A shows the rubber bush 60B prior to being fitted and secured in the through hole 111B. FIG. 7B shows the rubber bush 60B fitted and secured in the through hole 111B.

As shown in FIGS. 6, 7A, and 7B, the through hole 111B of the housing base 11B includes an inner surface 1111B, which is tapered from the air duct 30B side (in other words, “A” side in FIGS. 7A and 7B) to the main body side (in other words, “B” side in FIGS. 7A and 7B), similarly to the through hole 111 of the housing base 11. The housing base 11B has four screw holes 112B around the through hole 111B on the surface on the air duct 30B side.

The rubber bush 60B has an outer surface 63B, which is tapered corresponding to the inner surface 1111B of the through hole 111B, similarly to the rubber bush 60. The rubber bush 60B includes a plurality of (two in this embodiment) cable insertion holes 61B disposed in parallel to one another. The two cable insertion holes 61B are open at two opening end surfaces 611Ba and 611Bb. From the opening end surface 611Ba, two cylindrical protruding opening portions 62Ba (close contact portions) protrude in the insertion directions of the cables 90. From the opening end surface 611Bb, two cylindrical protruding opening portions 62Bb (close contact portions) protrude in the insertion directions of the cables 90. Each cable insertion hole 61B has an inner diameter that is larger than the outer diameter of the cable 90, similarly to the cable insertion hole 61 of the rubber bush 60. The cable insertion hole 61B has an inner surface 612B. With the rubber bush 60B fitted in the through hole 111B, the inner surface 612B receives pressure from the inner surface 1111B of the through hole 111B and expands in the inside direction. In this respect, with the cable 90 passed through the cable insertion hole 61B, the inner surface 612B is kept from close contact with the outer surface 901 of the cable 90 (in other words, only slight contact or no contact is permitted). The protruding opening portions 62Ba and 62Bb respectively have inner surfaces 621Ba and 621Bb continuous from the respective cable insertion holes 61B. The protruding opening portions 62Ba and 62Bb respectively have circumferential protruding portions 622Ba and 622Bb respectively at outer end portions of the inner surfaces 621Ba and 621Bb. With the rubber bush 60B fitted in the through hole 111B, the protruding portions 622Ba and 622Bb, respectively of the protruding opening portions 62Ba and 62Bb, come into close contact with the outer surface 901 of the cable 90 outside the through hole 111B (with a level of pressure that allows for movement of the cable 90 in its insertion directions).

The rubber bush 60B thus configured is fitted into the through hole 111B of the housing base 11B from the air duct 30B side and secured under the steel plate 70B. In this respect, the inner surface 612B of each cable insertion hole 61B of the rubber bush 60B expands in the inside direction due to the pressure from the inner surface 1111B of the through hole 111B. The inner surface 612B, however, is kept from close contact with the outer surface 901 of the cable 90 passed through the cable insertion hole 61B. Instead, the protruding portions 622Ba and 622Bb, respectively of the protruding opening portions 62Ba and 62Bb, of the rubber bush 60B come into close contact with the outer surface 901 of the cable 90 outside the through hole 111B. Thus, each cable through hole 61B is hermetically sealed. The steel plate 70B, which secures the rubber bush 60B, includes an insertion hole 71B and four screw insertion holes 72B, into which the screws 80 are to be screwed. The steel plate 70B is placed over the opening end surface 611Ba of the rubber bush 60B at the side of the air duct 30B and the surface of the housing base 11B at the side of the air duct 30B so as to permit the two protruding opening portions 62Ba of the rubber bush 60B at the side of the air duct 30B to pass through the insertion hole 71B. In other words, the steel plate 70B is placed to cover the gap between the rubber bush 60B and the through hole 111B at the side of the air duct 30B. Then, the four screws 80 are passed through the respective screw insertion holes 72B to be screwed into the respective screw holes 112B of the housing base 11B. Thus, the steel plate 70B is secured to the surface of the housing base 11B at the side of the air duct 30B.

This modification provides similar advantageous effects to those in the above-described embodiment. This modification also provides the following advantageous effects. In the above-described embodiment, the rubber bush 60 includes a single cable insertion hole 61 and thus has an approximately circular overall shape. The rubber bush 60B according to this modification includes two parallel cable insertion holes 61B and thus has an approximately oval overall shape. Because of its non-circular shape, the rubber bush 60B fitted and secured in the through hole 111B of the housing base 11B receives pressure that varies from position to position from the inner surface 1111B of the through hole 111B. This can cause an uneven close contact between the inner surface 612B of each cable insertion hole 61B and the outer surface 901 of the cable 90 passed through the inner surface 612B. The uneven close contact creates a possibility of degraded sealability. In view of this, this modification provides two protruding opening portions 62Ba and two protruding opening portions 62Bb in the rubber bush 60B, which includes two cable insertion holes 61B disposed in parallel to one another. The protruding opening portions 62Ba and 62Bb are not affected by the pressure from the inner surface 1111B of the through hole 111B, ensuring a uniform close contact with the outer surface 901 of the cable 90 outside the through hole 111B. Thus, even in the rubber bush 60B with two cable insertion holes 61B, the cables 90 are movable in their insertion directions without degraded sealability of the cable insertion holes 61B.

### (3) Other Modifications

In modification (2), the two protruding opening portions 62Ba and the two protruding opening portions 62Bb are respectively disposed at the two opening end surfaces 611Ba and 611Bb, at which the two cable insertion holes 61B of the rubber bush 60B are open. This, however, should not be construed in a limiting sense. It is also possible to dispose only the two protruding opening portions 62Ba at the opening end surface 611Ba, which is at the side of the air duct 30B, among the two opening end surfaces 611Ba and 611Bb.

In modification (2), the rubber bush 60B includes the two cable insertion holes 61B disposed in parallel to one another. This, however, should not be construed in a limiting sense. The present invention also finds applications in rubber bushes each having three or more cable insertion holes disposed in parallel to each other.

While in the above-described embodiments the bush is made of rubber, this should not be construed in a limiting sense. The bush may be made of an elastic member other than a rubber member.

It will be appreciated that various embodiments and modifications described herein may be readily combined.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A motor control apparatus configured to control driving of a motor, the motor control apparatus comprising:
a housing base having a first surface and a second surface;
a main body on the first surface of the housing base, the main body comprising a plurality of electronic components associated with driving of the motor;
an air duct through which cooling air flows on the second surface of the housing base;
a through hole in the housing base, the through hole having a tapered inner surface;
a bush fitted and secured in the through hole, the bush having a tapered outer surface and comprising at least one cable insertion hole and at least one close contact portion; and
at least one cable disposed through the at least one cable insertion hole and the housing base and wired between the main body and the air duct, the at least one cable having an outer surface in close contact with the at least one close contact portion of the bush outside the through hole.

2. The motor control apparatus according to claim 1, wherein the at least one cable insertion hole of the bush is open at two opening end surfaces, and the at least one close contact portion comprises at least one cylindrical protruding opening portion protruding from at least one of the two opening end surfaces in an insertion direction of the at least one cable, the at least one protruding opening portion having an inner surface continuous from the at least one cable insertion hole and comprising a circumferential protruding portion on the inner surface.

3. The motor control apparatus according to claim 2, wherein the at least one protruding opening portion comprises two protruding opening portions at the respective two opening end surfaces.

4. The motor control apparatus according to claim 2, wherein one opening end surface among the two opening end surfaces of the at least one cable insertion hole is disposed at a side of the air duct side, and the at least one protruding opening portion is disposed at the one opening end surface.

5. The motor control apparatus according to claim 1, wherein the at least one cable insertion hole of the bush has an inner diameter larger than an outer diameter of the at least one cable.

6. The motor control apparatus according to claim 1,
wherein the at least one cable insertion hole of the bush comprises a plurality of cable insertion holes disposed in parallel to each other,
wherein the at least one cable comprises a plurality of cables disposed through the plurality of respective cable insertion holes, and
wherein the at least one close contact portion comprises a plurality of close contact portions each in close contact with an outer surface of a corresponding cable among the plurality of the cables outside the through hole.

7. The motor control apparatus according to claim 1,
wherein the tapered inner surface of the through hole of the housing base is tapered in a direction from the air duct to the main body, and
wherein the bush is fittable into the through hole from a side of the air duct and secured with a clamping plate.

8. A bush for a motor control apparatus,
the motor control apparatus comprising:
a housing base having a first surface and a second surface;
a main body on the first surface of the housing base, the main body comprising a plurality of electronic components associated with driving of the motor;
an air duct through which cooling air flows on the second surface of the housing base;
and a through hole in the housing base, the through hole having a tapered inner surface;
the bush comprising:
a tapered outer surface so that the bush is fitted and secured in the through hole;
a cable insertion hole through which a cable is disposed to pass through the housing base and be wired between the main body and the air duct; and
a close contact portion in close contact with an outer surface of the cable outside the through hole.

9. The motor control apparatus according to claim 2, wherein the at least one cable insertion hole of the bush has an inner diameter larger than an outer diameter of the cable.

10. The motor control apparatus according to claim 3, wherein the at least one cable insertion hole of the bush has an inner diameter larger than an outer diameter of the cable.

11. The motor control apparatus according to claim 4, wherein the at least one cable insertion hole of the bush has an inner diameter larger than an outer diameter of the cable.

12. The motor control apparatus according to claim 2,
wherein the at least one cable insertion hole of the bush comprises a plurality of cable insertion holes disposed in parallel to each other,
wherein the at least one cable comprises a plurality of cables disposed through the plurality of respective cable insertion holes, and
wherein the at least one close contact portion comprises a plurality of close contact portions each in close contact with an outer surface of a corresponding cable among the
plurality of the cables outside the through hole.

13. The motor control apparatus according to claim 3,
wherein the at least one cable insertion hole of the bush comprises a plurality of cable insertion holes disposed in parallel to each other,
wherein the at least one cable comprises a plurality of cables disposed through the plurality of respective cable insertion holes, and
wherein the at least one close contact portion comprises a plurality of close contact portions each in close contact with an outer surface of a corresponding cable among the plurality of the cables outside the through hole.

14. The motor control apparatus according to claim 4,
wherein the at least one cable insertion hole of the bush comprises a plurality of cable insertion holes disposed in parallel to each other,
wherein the at least one cable comprises a plurality of cables disposed through the plurality of respective cable insertion holes, and
wherein the at least one close contact portion comprises a plurality of close contact portions each in close contact with an outer surface of a corresponding cable among the plurality of the cables outside the through hole.

15. The motor control apparatus according to claim 5,
wherein the at least one cable insertion hole of the bush comprises a plurality of cable insertion holes disposed in parallel to each other,
wherein the at least one cable comprises a plurality of cables disposed through the plurality of respective cable insertion holes, and
wherein the at least one close contact portion comprises a plurality of close contact portions each in close contact with an outer surface of a corresponding cable among the plurality of the cables outside the through hole.

16. The motor control apparatus according to claim 9,
wherein the at least one cable insertion hole of the bush comprises a plurality of cable insertion holes disposed in parallel to each other,
wherein the at least one cable comprises a plurality of cables disposed through the plurality of respective cable insertion holes, and
wherein the at least one close contact portion comprises a plurality of close contact portions each in close contact with an outer surface of a corresponding cable among the plurality of the cables outside the through hole.

17. The motor control apparatus according to claim 10,
wherein the at least one cable insertion hole of the bush comprises a plurality of cable insertion holes disposed in parallel to each other,
wherein the at least one cable comprises a plurality of cables disposed through the plurality of respective cable insertion holes, and
wherein the at least one close contact portion comprises a plurality of close contact portions each in close contact with an outer surface of a corresponding cable among the plurality of the cables outside the through hole.

18. The motor control apparatus according to claim 11,
wherein the at least one cable insertion hole of the bush comprises a plurality of cable insertion holes disposed in parallel to each other,
wherein the at least one cable comprises a plurality of cables disposed through the plurality of respective cable insertion holes, and
wherein the at least one close contact portion comprises a plurality of close contact portions each in close contact with an outer surface of a corresponding cable among the plurality of the cables outside the through hole.
